(19) United States
(12) Patent Application Publication
(10) Pub. No.: US 2026/0339279 A1
(43) Pub. Date: Oct. 29, 2026

(54) HARMONIZING PARAMETER DATA FOR USE IN DIGITAL TWINS

(71) Applicant: PAUL WURTH S.A., Luxembourg (LU)

(72) Inventors: Cédric SCHOCKAERT, Wiltz (LU); Fabrice HANSEN, Doncols (LU)

(21) Appl. No.: 19/485,746

(22) PCT Filed: Jun. 13, 2024
(86) PCT No.: PCT/EP2024/066487

§ 371 Date: Nov. 19, 2025

(30) Foreign Application Priority Data
Jun. 16, 2023 (LU) LU504528

(51) Int. Cl. G05B 13/02; G06N 3/08

(52) U.S. Cl. CPC G05B 13/027; G06N 3/08

(57) ABSTRACT

In a computer-implemented method for harmonizing parameter data, a computer receives from a component of an industrial machine—a source parameter dataset that represents a technical parameter. The source parameter dataset has a source parameter identifier and a source parameter value. The computer uses a first pre-trained sub-network to match the source parameter identifier to a target parameter identifier. The computer uses a second pre-trained sub-network to match the source parameter value to a target parameter value. The second sub-network is being selected according to the target parameter identifier. The computer forwards both the target parameter identifier and the target parameter value to a user-interface that shows a user-interface element that corresponds to the component of the industrial machine and that visualizes the target parameter value.

### CROSS-REFERENCE TO RELATED APPLICATIONS

This application is a 35 U.S.C. § 371 National Stage patent application of PCT/EP2024/066487, filed on 13 Jun. 2024, which claims the benefit of Luxembourg patent application no. 504 528, filed on 16 Jun. 2023, the disclosures of which are incorporated herein by reference in their entirety.

### TECHNICAL FIELD

In general, the disclosure relates to industrial processes, and more in particular, the disclosure relates to computer systems, methods and computer-program products to visualize harmonized parameter data in user-interfaces.

### BACKGROUND

From a high-level perspective and much simplified, an industrial system is a technical system that performs an industrial process, such as for example to process materials with the goal to obtain products. Parameters are characteristics that are related to the industrial process (and/or to the industrial system) and that may influence the performance of the process (and/or the operation of the system). To name only some examples, a parameter can be a physical phenomenon (such as temperature or pressure), can be the indication of quality and quantity of the material that is being processed, or can be any other characteristic.

The industrial system can be considered to have multiple components, and knowledge of component-specific parameter values is a condition to operate the system.

In a fictitious example for an industrial system, a number of industrial machines is located at a manufacturing site. System components should include a compressor to provide air, a pipe network that distributes the compressed air, and the machines that use the compressed air. To measure the air pressure, the components are associated with pressure meters. The system operators consider the pressure values to control the system. Much simplified, the operators let every machine receive air at appropriate pressure.

Traditionally, the meters would be implemented as pressure gauges (or “manometers”) with a mechanical pointer that rotates over a dial. Human operators would visually inspect the meters from time to time. As the machines (and their meters) do not necessarily have the same manufacturing origin, the pointers and dials may vary in appearance. For example, the operators can see the pressure at a first machine by a red pointer that moves over a white dial with odd numbers (“1, 3,5, 7, 9 . . . ”), or the operators can see the pressure at a second machine from a black pointer over a yellow dial with even numbers (“2, 4, 6 . . . ”).

The operators understand that certain pressure values (i.e., meter readings) require immediate actions, but also understand that critical values may differ between the machines. For example, the operators would open a valve at the first machine when the pressure value has reached “7”, but would act for the second machine at “10”.

However, industry changes, and therefor more and more meters are replaced by digital sensors. As used herein, a digital sensor is a computing device that
senses a physical phenomenon that is a parameter, and that
provides a parameter value in the form of digital data.

In other words, data from the digital sensor represents one or more technical parameters. A digital pressure sensor still has a mechanical part attached to the pipe, but it also has electronics with analog-to-digital converters or the like to provide the data. In many cases, the digital sensors comprise small computing functions (microprocessors, controlled by software) that pre-process the data, for example but adding meta-data (time-stamps, identification of the machine, of the sensor, etc.)

With such an approach, the operators do not have to walk in person through the manufacturing site to look at the meters any longer. Instead, the operators may sit in control rooms. Some of the control rooms may be located at remote sites. As the operators do no longer interact with the components manually, actuators receive control signals from the control room.

There is a trend in industry to represent individual industrial systems and their components virtually by so-called “digital twins”. The twin metaphor stands for the relation between the systems in reality and its virtual representation by computers. Each industrial system would have its “system twin”, each component would have its “component twin”, and so on.

Representing industrial machines by digital data (as “twins” or otherwise) makes it easier to extend control loops into the control room (e.g., to automatically open at “7” via an actuator at a pressure valve), but also enables the computers to anticipate some of the actions. For example, the computers could decide to open valves (or to close them, or to keep them closed) by taking other data into account. The computers could even simulate the operation of the machines, and -depending on the outcome of the simulation-the computers may start (or stop) an action.

There is a further trend to operate industrial machines autonomously (i.e., by limiting machine-operator interaction) and the provision of comprehensive data regarding the machine is one of the enablers for such autonomy.

The pressure meters have the common property (or nature) that they all measure pressure. But as the pointers and dials of the meters are replaced by pre-defined data-structures of digital sensors, different sensor manufacturers may use different data conventions. In other words, communication between the systems and the twins is far away from being standardized.

Different data conventions may lead to inappropriate actions: A computer that processes incorrect data may generate control signals at the wrong time (or in incorrect meaning). In the example, the computer may receive pressure data from the first machine but may process that pressure data according to the configuration of the second machine. The computer may open the valve at the first machine too late, when the pressure has reached “10”, but not earlier when the pressure has reached “7”. In other words, the “twins” should match the original, otherwise failures can occur.

Although the example to measure the pressure is convenient for illustration, data is not limited to pressure data. Every machine provides data for multiple parameters.

Using a sensor fleet in that all digital sensors provide data according to a standardized identical data convention is usually note feasible.

US 2018/0356800 A1 discloses a computer platform to process industrial data that originates from different sources. Processing has the focus on analytics and on predicting events

### SUMMARY

According to embodiments of the present disclosuredisclosure, data harmonization is performed by processing source data to target data by a pre-trained neural network. The neural network has learned relations between source and target data from processing historical data that is available in the form of time-series.

Such a machine learning approach may be advantageous because historical data summarize previous harmonization activities. As harmonizing the data conventions can be error-prone if done manually, the process to train the neural network would ignore occasional inconsistencies in historical data records. In other words, a human expert may have introduced some incorrect harmonization somewhere in a time-series, but would have correctly harmonized the data in the larger part of the time-series.

A computer-implemented method is disclosed as a method for harmonizing parameter data.

In a receiving step, the computer receives—from a component of an industrial machine—a source parameter dataset that represents a technical parameter. The technical parameter belongs to the component. The source parameter dataset has a source parameter identifier and has a source parameter value.

In a first matching step, the computer using a first sub-network of a pre-trained neural network. It matches the source parameter identifier to a target parameter identifier. (The first pre-trained sub-network has been trained with a plurality of historical parameter identifier pairs with historical source parameter identifiers at its input and historical target parameter identifiers at its output).

In a second matching step, the computer uses a second sub-network of the pre-trained neural network. It matches the source parameter value to a target parameter value. The second sub-network of the pre-trained neural network, is being selected according to the target parameter identifier, and it has been trained with a plurality of historical parameter value pairs with historical source values at its input and historical target values at its output.

In a forwarding step, the computer forwards both the target parameter identifier and the target parameter value to a user-interface that shows a user-interface element that corresponds to the component of the industrial machine and that visualizes the target parameter value.

Optionally, the source parameter dataset (that represents a technical parameter that belongs to the component) is a source parameter dataset from a digital sensor, or is a source parameter dataset from a virtual sensor.

Optionally, the first sub-network—in addition to having been trained with a collection of parameter identifier pairs—has simultaneously been trained with historical context data at its input.

Optionally, the second sub-network—in addition to having been trained with a collection of parameter value pairs—has simultaneously been trained with historical context data at its input.

Optionally, in step receiving, the computer further identifies real-time context in that the component currently operates. The real-time context is a collection of data-points that are related to the data-point in the source parameter dataset for the technical parameter.

Optionally, in step receiving, the computer identifies the real-time context and thereby accesses state data.

Optionally, in step forwarding, the computer uses a user-interface to visualize the target parameter value by a symbol.

Optionally, after receiving the source parameter dataset, the computer uses the first and second sub-networks to determine if the source parameter dataset fits a convention for the target parameter dataset. For a positive determination, the method continues with forwarding, thereby skipping the matching steps.

Optionally, the method-executing computer—after receiving the source parameter dataset—can use a context network to perform identifying a context type, and can select a particular first sub-network according to the context type, to match the source parameter identifier to the target parameter identifier.

Optionally, forwarding is followed by obtaining control signals to control the operation of the component of the industrial machine.

The disclosure also relates to using the method for harmonizing parameter data by a computer system that specifies control data and that sends the control signals to one or more components of one or more industrial machines.

A computer system is adapted to perform the method for harmonizing parameter data from a component of an industrial machine (as summarized here with its steps and with its optional step details).

From the perspective of training, a computer-implemented method for training a neural network is disclosed. The neural network has a first sub-network and has a second sub-network, and the neural network is trained for subsequent use in a computer-implemented method for harmonizing parameter data from a plurality of source conventions to a single target convention. Data flows through the first and second sub-networks from inputs to outputs.

Parameter data relate to components of industrial machines, and parameter datasets represent technical parameters that belong to the components of the machines, wherein the parameter datasets have parameter identifiers and have parameter values.

In the source conventions, there are source parameter identifiers and source parameter values and in the single target convention, there are target parameter identifiers and target parameter values.

The method comprises training the first sub-network with a plurality of historical parameter identifier pairs, with historical source parameter identifiers at the input of the first sub-network and with historical target parameter identifiers at the output of the first sub-network.

The method further comprises training the second sub-network with a plurality of historical parameter value pairs with historical source values at the input of the second sub-network and historical target values at the output of the second sub-network.

A computer program product that—when loaded into a memory of a computer and being executed by at least one processor of the computer causes the computer to perform the steps of the method for harmonizing or the steps of the method for training.

### BRIEF DESCRIPTION OF THE DRAWINGS

Embodiments of the present disclosuredisclosure will now be described in detail with reference to the attached drawings, in which:

FIG. 1 illustrates an industrial machine, a user interface on a remote computer and a machine operator;

FIG. 2 illustrates machine data written as multi-variate time-series with data-points;

FIG. 3 illustrates a plurality of system components with digital sensors, a translation function for harmonizing parameter data, and a plurality of digital component equivalents that process the target data;

FIG. 4 repeats the illustration of FIG. 3 at least partly but shows the translation function in an implementation with a neural network;

FIG. 5 illustrates the function of the neural network to provide syntax translations;

FIG. 6 illustrates the function of the neural network to provide semantic translations;

FIG. 7A illustrates a flow-chart of computer-implemented method for harmonizing parameter data;

FIG. 7B illustrates a flow-chart of computer-implemented method for harmonizing parameter data, with applying a context-sensitive network selection cascade;

FIG. 8 illustrates machine components having different sensor implementations;

FIG. 9 illustrates first, second, and third industrial machines each having a plurality of components, in communication with digital equivalents—or twins—via the neural network; and

FIG. 10 illustrates a generic computer.

### DETAILED DESCRIPTION OF THE DRAWINGS

### Overview

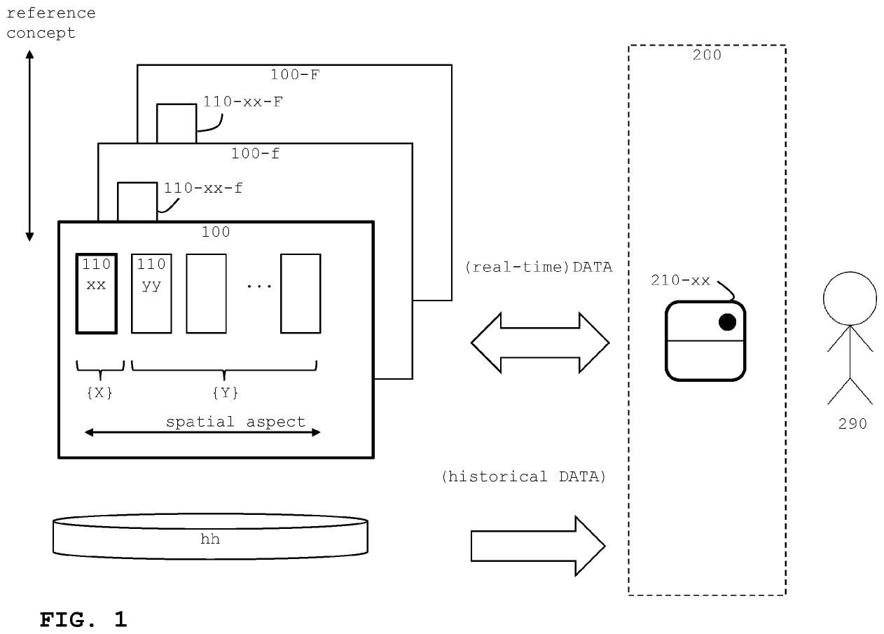

FIG. 1 illustrates industrial machine 100, and also illustrates a plurality of further industrial machines, here having references 100-f and 100-F. All machines together can be considered as a fleet of machines. Machine 100 comprises component 110-xx and comprises further components 110-yy. The further machines comprise further components as well.

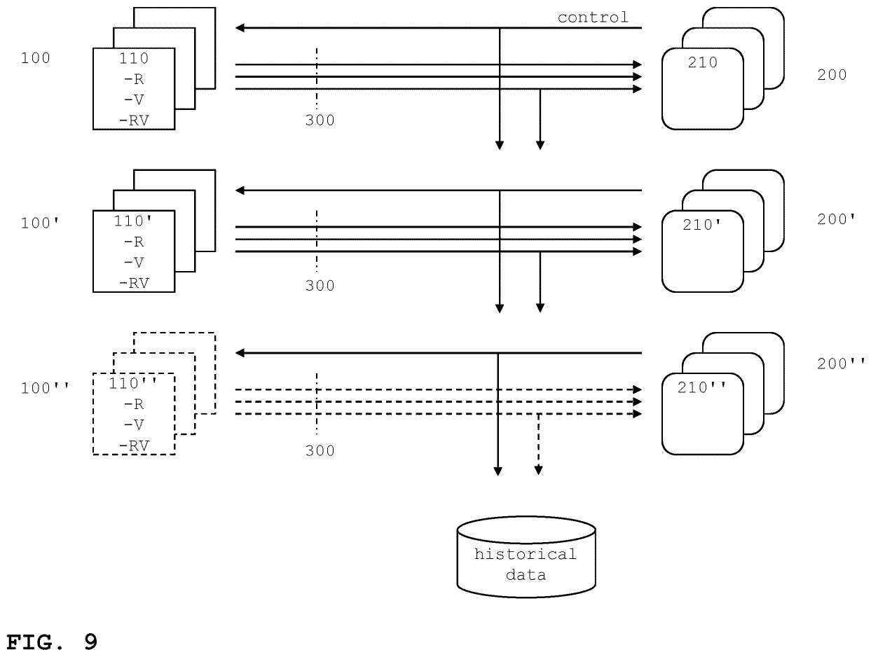

Almost any component of the machine is associated with parameter data, such as
measurement data (i.e., data obtained from the component via sensors or the like),
quasi-measurement data (i.e., data in the function of measurement data, from “virtual sensors”, cf. FIG. 9)
control data (i.e., data provided to the component, such as data to modify a parameter),
environment data (i.e., data that describes the environment outside the component, with potential influence on the machine),
production data (i.e., data that describes the materials, products, tools etc.), and so on.

From a very high-level perspective, data will be processed by computers, among them a computer that is symbolized by its user-interface 200. Machine 100 (also 100-f and 100-M) is communicatively coupled with that computer. Operator 290 is the user of this computer.

As the computers do not process all available data, but process selected data for particular purposes, such as remotely controlling the machine(s), it is convenient to discuss data in some aspects. Some data processing involves the use of computer modules that are trained by data, such as neural networks.

Data in Space and Time: Spatial and Temporal Aspects

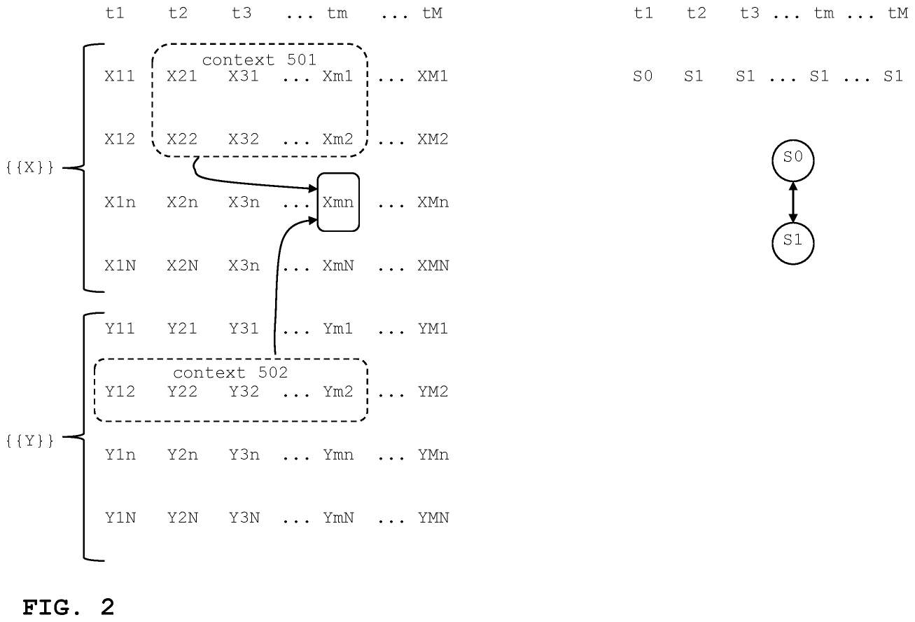

FIG. 2 illustrates machine data written as multi-variate time-series with data-points. The figure shows a first data matrix {{X}} and a second data matrix {{Y}}, as well as the progress of time (t1, t2, . . . , tm, . . . , tM). Index m stands for the current time tm, and indices smaller m stand for the past time, and indices larger m stand for the future time.

Data-points X and Y have a column index for the time-points (index m=1 to M) and have a row index for multiple variates (index n=1 to N). For simplicity of explanation, M and N as well at the time-interval At between consecutive time-points tm and t(m+1) should be equal for {{X}} and for {{Y}}. In implementations, the data-points can be identified otherwise, and assuming equal At merely simplifies the description.

Returning to FIG. 1, in a spatial aspect, data can be further differentiated according to the physical location that is associated with the origin of the data-point.
In a first example, as different components are necessarily located at different physical locations within machine 100, multi-variate time-series {{X}} in association with component 110-xx is different from further multi-variate time-series {{Y}} (in association with components 110-yy). FIG. 1 illustrates the spatial aspect by a horizontal line for the first example. The granularity by that component data {{X}} is differentiated from component data {{Y}} is based on the structure of the machine having components.
In a second example, as sensors (or other data providers) are associated with different physical locations within component 110-xx, a single time series {X} for variate n within {{X}} of component 110-xx has spatially different data in the other variates of {{X}}. For simplicity of explanation, FIG. 1 does not illustrate the second example, but the principle remains the same: components have sub-components, and again simplified, sub-components can be related to individual variates.

A parameter can be distributed along sub-components. For example, the temperature distribution may differ across a surface so that the temperature values would be obtained as a function of surface location (x, y), and of time.

A temporal aspect refers to the relation between past, present and future.

A time-series (single-variate, or multi-variate) can be differentiated into a real-time portion and a historical portion.
The real-time portion comprises data that represents circumstances that may influence the operation of the component (and of the machine) at present (index m) or in the future (index>m). For a single variate time series, the portion can comprise data-points with indices (m−K), . . . , (m−k), (m−1) and m. K is a “view-back” counter. For multi-variate time-series, counter K can be different for each variate.
The historical portion represents circumstances that do not longer influence the operation. Simplified, it comprises data-points outside the reach of counter(s) K.

Simplified and without the need for a sharp distinction here, real-time data can be used for controlling the machines, and historical data can be used for training networks or the like.

The database symbol with index “hh” symbolizes the availability of historical data, for {{X}} and for {{Y}} (ideally for all components, all machines). Index hh can correspond to index xx, but does not have to.

### Context Concept

FIG. 2 also illustrates the concept of context by dashed rectangles 501, 502 or “context windows”. The context concept takes both the spatial aspect and the temporal aspect into account. Data-point Xmn has one or more contexts. As used herein, a context is a collection of data-points (illustrated by dashed rectangles) that are related to data-point Xmn.

A context (i.e., the collection) may vary, and in principle each data-point has its own context. In the example, data-point Xmn (i.e., data relating to variate n at time-point tm) may be related to data within the same multi-variate time-series {{X}} for component 110-xx. Context 501 is available, for example, as the collection of data-points X21, X31 and Xm1 for variate 1 and data-points X22, X32 and Xm2 for variate 2. Context 501 can be considered as a two-dimensional context, with the dimensions (or aspects) in time and in the variates.

Data-point Xmn may also have context 502: data-points Y12, Y22, Y32, Ym2 (variate 2, further component 110-yy). Context 502 is a one-dimensional context (in time) Contexts can be defined by rules, such as
human-made rules that take relations between parameters into account, or
machine-learned rules that are based on observations (for example by a computer processing historical data).

Contexts do not have to be known a priori, but can be learned.

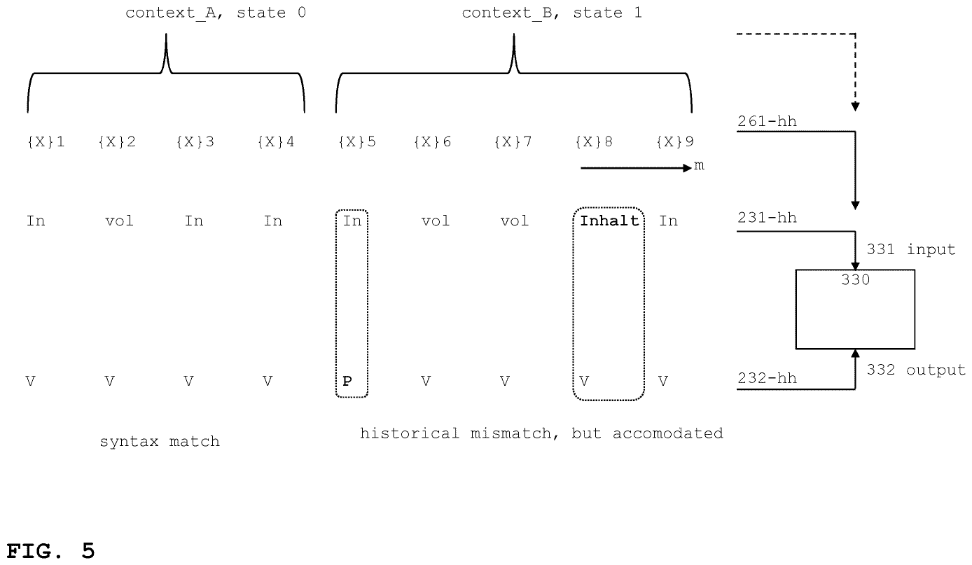

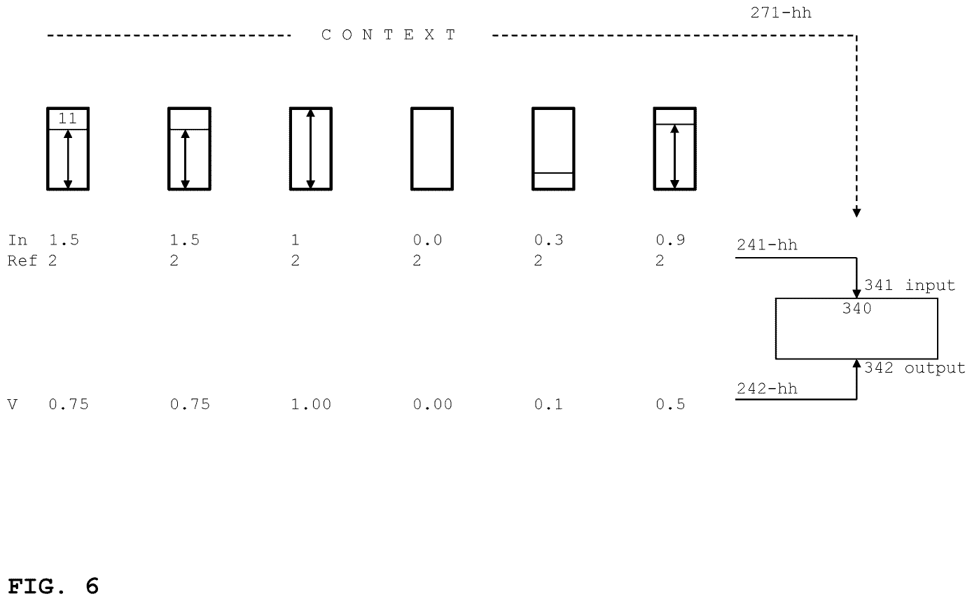

Contexts can be differentiated into real-time context and historical context:
As FIG. 2 illustrates time-series in real-time (time index m stands for the current time, as explained), the parameter that are represented by data in the dashed rectangles 501 and 502 influence Xmn as it is at tm. Context 501 and 502 is therefore real-time context.
If multi-variate time-series {{X}} or {{Y}} are part if historical data (cf. index hh in the collection of FIG. 1), the data in the dashed rectangles 501 and 502 had influenced Xmn. It had been the real-time context in the past, and it can be considered as the historical context. Historical context can be applied in a training phase (cf. FIGS. 5-6).

Optionally, context can be established by having temporal aspects and spatial aspects in hierarchy:

The temporal aspects may have priority over spatial aspects. For example, going back in time by a pre-defined number of Δt (e.g., by back-view counter K) provides a time context window. Within that window some variates would contribute to context, and some not.

The spatial aspects may have priority over the temporal aspects as well. For example, some variates my be related and some may be un-related (computers could learn that) and the computer would further learn how many At the temporal window could be opened for the related variates.

Contexts can further be differentiated according to granularity levels, and the description gives two extremes: The “big picture context” can be, for example, defined by data-points that apply to substantially all machines at a particular industrial site at particular times of the year. For example, the first big picture context could be defined by the month June (i.e., the time-points in June) for a location in Asia (with an implicit assumption to have relatively high air humidity), and the second big picture context could be defined by the month December for a location in Europe (dry, but cold). The big picture contexts can be enhanced by further sub-context that comprise material consumption, failure rates, relative share of process states and so on.

The “micro context” could be data-driven as in FIG. 2. Arranging contexts across granularity (from “big” to “small” or vice versa) and under consideration of hierarchy (i.e., sub-contexts) can be advantageous in view of computation. More context details (“small”) may require more computation than less context details (“big”).

### Reference Concept

FIG. 1 also illustrates a reference concept by a vertical line. The reference concept is complementary to the context concept.

Component 110 (in machine 100), component 110-xx-f (in further machine 100-f), and component 110-xx-F (in further machine 100-F) are similar components. One machine can have two or more similar components. As used herein, components are similar if they have
a common structural element, and
a common parameter that is related the that structural element.

Consequently, similar components can be used as reference (for several purposes, such as for harmonizing parameter data).

Although not discussed here, it is possible that an industrial machine has multiple components that are also similar to each other.

### Component States and Machines States as Data Derivatives

FIG. 2 also illustrates states that may change over time. The data-points in {{X}} (and in {{Y}}) can be processed according to pre-defined rules to obtain states, usually by aggregation. There is no need to process all data, processing some variates is usually sufficient.

FIG. 2 illustrates states S0 and S1 by way of example. Simplified, at any given point in time, machine 100 (or component 110-xx, or 110-yy) may assume a particular state. States can be differentiated into machines states (states derived from {{X}} and from {{Y}}) and components states (states derived from {{X}} of a component).

States can contribute to reference and to context (i.e., to the determination of reference and of context). States can be related to the process that machine 100 performs. In other words, while contexts 501 and 502 are collections or data-points, further contexts can be defined by
collections of data-points and time-series with states (as the series S0, S1, S1, S1, S1 in FIG. 2), and
time-series with states (as the series S0, S1, S1, S1, S1 in FIG. 2), and also collections of such time-series.

### EXAMPLE

For example, component 110-xx could be a vessel (or tank) of industrial machine 100. Data-point Xmn should represent the volume of material (such as a liquid) that has been poured into the vessel. In an industrial process, component 110-xx should receive the material at a certain volume per time (“material flow” as variate 1 in {{X}}) and at a certain temperature (variate 2 in {{X}}). Some of the time-points belong to a current performance of the process (cf. context 501), and some time-points (e.g., t1) do not. Again simplified, time-points within back-view counter K are “real-time, the others are ”historical“.

In the example, the material flow into the vessel and the temperature of the material during certain past time-points gives context 1, because the vessel is being filled with material (during that time-points). As vessels are made empty from time to time (for cleaning or other maintenance), not every time-point in the past would belong to context.

Regarding similarity, component 110-yy could be a vessel as well, and the {Y} series for variate n should represent the volume of a material as well (i.e., data-point Ymn). Ymn would have a different context (not context 501), but due to the similarity (both are vessels, variates 1, 2 and n are likewise), component 110-yy could serve as reference.

Regarding the states, S0 could be a state in that the material volume remains unchanged, and S1 could be a state in that the material volume increases or decreases. In the example, the rules would be simple: variate 1 with material going into the vessel (or out from the vessel) AND variate n increasing over time would describe state S1, otherwise the state would transition to state S0.

As already mentioned, states (and state transitions) can belong to context, but they do not have to.

The description will return to such simplified examples when it explains the training of the network.

### Data Flow to Operator

As mentioned above, operators interact with the machines remotely, and FIG. 1 symbolizes this approach by showing user interface 200 (of a computer) and operator 290. In principle, operator 290 has access to {{X}} (and also to {{Y}}), cf. FIG. 2. Placing data-points into context (such as contexts 501, 502), establishing inter-component references, and even aggregating data to states (cf. S0, S1) enhances the data.

Such data enhancement can be regarded as a measure that supports operator 290. For example, operator 290 may look at a digital component equivalent 210-xx in user interface 200 telling him that-for example-the liquid volume in component 201-xx changes (i.e., an aggregated status information, state S1), that component 110-xx participates in a particular process step (i.e., that is context as well), and that it has a particular relative volume (information obtained by referring to other components 110-xx-f or 110-xx-F acting as peers).

The bi-directional arrow DATA symbolizes that data from machines 100 goes to the computer and -at least to some extend-control data goes to machine 100.

The uni-directional arrow DATA symbolizes that historical data hh is available to operator 290 as well.

DATA could include data that has been pro-processed to context, to states, to references and so on, but the physical location of pre-processing does not matter.

### Constraints in the Flow

As mentioned above, different data conventions may lead to incorrect activities, and—even worse—different data conventions may further disturb digital component equivalent 210-xx. It may also lead to incorrect determination of context, states, references and so on.

In other words, similarity (such as for the components) does not mean to have data-equivalence (for the components as well). In terms of {{X}} and {{Y}}, the data would be different.

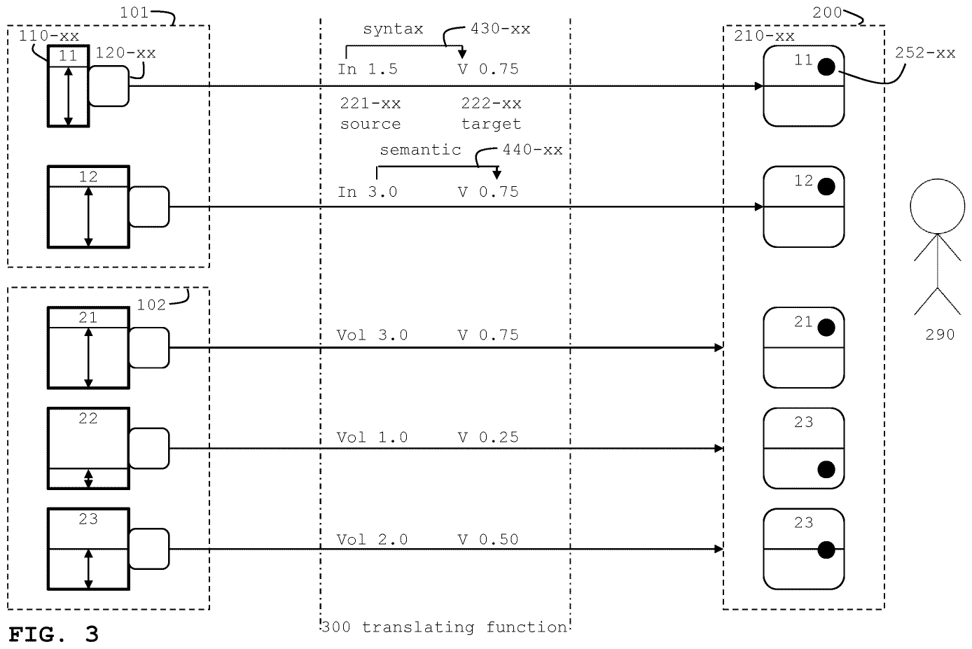

The structural elements may differ in quantity (cf. an example with differently sized vessels, in FIG. 3 with smaller and larger vessels), and parameters—although common—may be represented by different data structures.

### Solution

The constraints call for a solution. In the following it will be presented by harmonizing parameter data with a network-supported translation approach. Optionally, the network takes (one or more) contexts into account.

The description occasionally uses the term “translation” because at semantic and syntactic levels, a computer converts source data to target data, and in case of multiple but different sources the computer would provide target data in a single format.

The computer does—however—not perform natural language processing. The data is not available in such form. The computer rather performs a translation that could be compared to compiling source code into machine code (conversion between artificial languages, not between natural languages), but the translation function has to learn the details before applying them. Learning is explained here as training one or more networks.

### Excurse

A commercially available translation computer may use a pre-trained network to translate natural language text from a source language to a target language. The computer may have been trained to recognized patterns. For example, the phrase “ich bin gerade dabei, ein Buch zu . . . ” (in German) has the meaning to “I am in the process of . . . a book”. The ellipsis could be replaced by a verb such as “schreiben/write” or “lesen/read”. The training data for that computer seems to have much more statements with “write” than with “read”. Relatively high occurrence frequency (in the training data) determines the selection of a particular pattern in the target. Therefore, the computer would translate to the target “I am in the process of writing a book” even if the source does not specify if it should be “write” or “read”.

However, for source and target data for industrial machines, the occurrence frequency of particular events does not matter. Component 110-xx (if being a vessel) may eventually overflow (even in the real sense of that word: liquid would run out from the vessel), but such an event (or even failure state) may have a relatively low occurrence in historical data (cf. hh). Nevertheless, confusions or assumptions to opposite meanings must be avoided. Even if spill-over events are rare, they must be correctly identified in the target.

Optionally, the solution takes the context into account. That approach avoids a “translation” to majority-preferred target conventions in situations in that minority occurrences would apply.

### Components, Translations and Component Equivalents

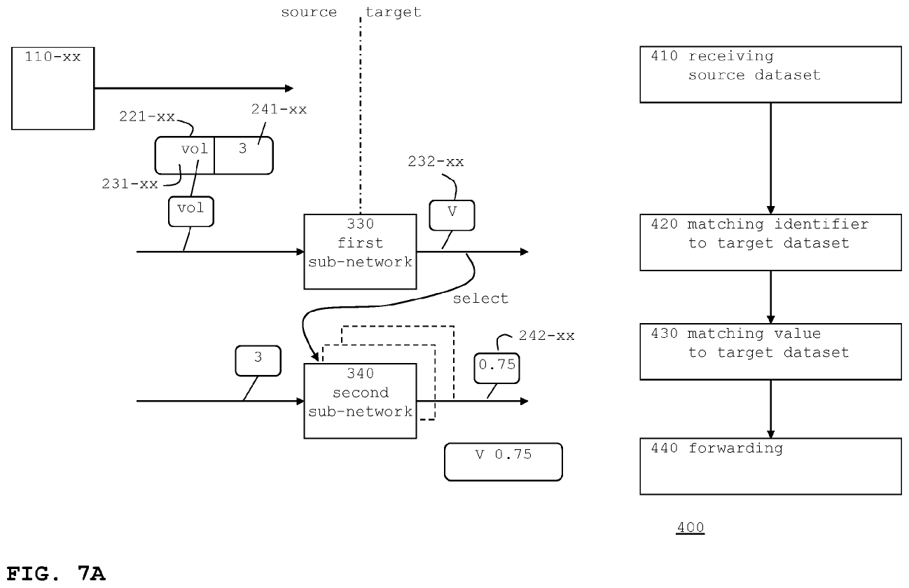

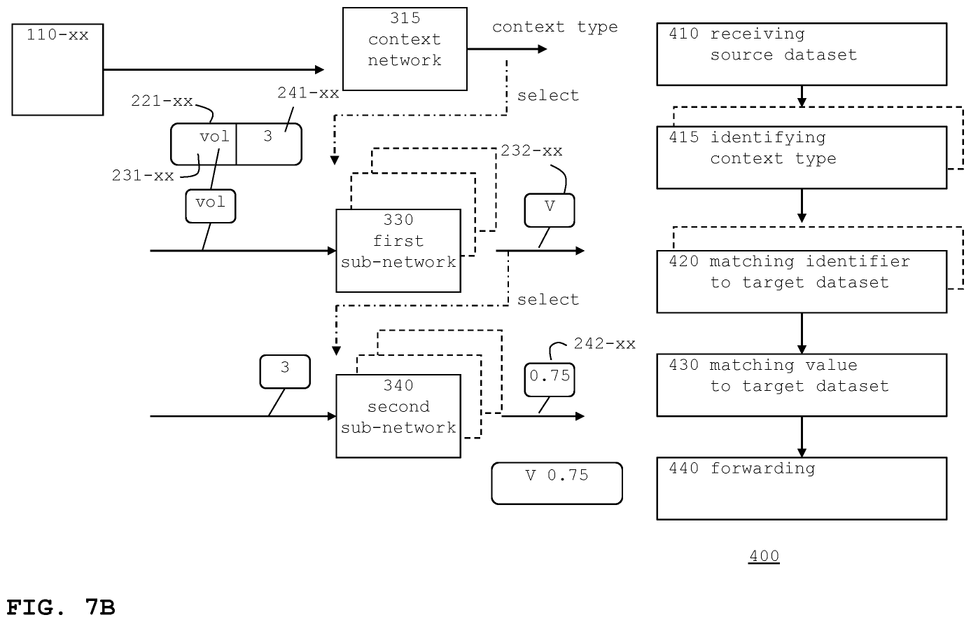

FIG. 3 illustrates
a plurality of system components 110-xx having digital sensors 120-xx that provide source data 221-xx,
a translation function 300 (dashed-dotted line) for harmonizing parameter data from digital sensors by performing a computer-implemented method (cf. method 400 in FIG. 7A) with converting source data 221-xx to target data 222-xx, and
a plurality of digital component equivalents 210-xx (or “digital component twins”) that process target data 222-xx (in the simplified example of FIG. 3 leading to symbol 252-xx on a user-interface).

FIG. 3 also illustrates—as actions—data-translations 430-xx and 440-xx by that translation function 300 translates source data 221-xx to target data 222-xx. The references 430 and 440 are that of the method (cf. FIG. 7A).

The dashed-dotted line for the translation function will show up in other figures as well. Such lines will illustrate the application of the method in use-case scenarios (cf. FIG. 9).

Pluralities (of components, actions, twins etc.) are differentiated by two-digit indices xx=(11, 12, 21, 22, 23). Same xx indices also indicate relations. Elements with the same xx would be related, and the figure gives such relations horizontally (e.g., component 110-11, translations 430-11 and 440-11, equivalent 210-11).

Digital equivalents 210-xx could be models that describe the components. Here in this figure, the equivalents are merely “mentioned” by user interface symbols (e.g., symbol 252-xx in FIG. 3).

Components 110-xx are similar in the sense that they all have a particular parameter (e.g., level or volume), or “common parameter”, cf. the introduction of that concept in FIG. 1. Components 110-xx can be belong to different technical systems, and there is no need that components 110-xx interact with each other. For example, components 110-11 and 110-12 belong to group 101 but they do not have to interact with each other, components 110-11 and 110-12 have their own contexts, and the contexts may vary over time. The parameter-although common does not have to have the same parameter value.

The figure is simplified in that a particular component 110-xx is illustrated with a single digital sensor 120-xx that provides (digital) source data 221-xx (to be translated 430-xx and 440-xx). Digital sensors 120-xx provide data at least for the common parameter. Of course, components may have other sensors for other parameters, not discussed here. Some sensors may provide data for more than one parameter.

Translation function 300 (that performs steps 430-xx and 440-xx of method 400, FIGS. 7A, 7B) provides (digital) target data 222-xx to particular equivalent 210-xx. Individual translations 430-xx and 440-xx are symbolized by right-going arrows.

As illustrated by dashed rectangles, components 110-11, 110-21 (and their digital sensors 120-11, 120-21) form a first component group 101 and components 110-21, 110-22, 110-23 (and their sensors 120-21, 120-22, 120-23) form a second component group 102.

Both groups could belong to different physical locations. For example, the groups could be located in two halls of the same site, or they could belong to two different machines (cf. FIG. 1). As illustrated by dashed lines, the digital equivalents 210-11, 210-12, 210-21-, 210-22, 210-23 would be available by a single computer (that would receive target data 222-11, 222-12, 222-21, 222-22, 222-23). Operator 290 would watch symbols of the components on a screen or the like. The figure is simplified in showing one operator 290, but there could be multiple operators, for different groups for example. Operating components and/or operating industrial machines at different physical locations but feeding data to a single computer may lead to constraints or may make the constraints more severe. The description will discuss some of the constraints below.

Of course, an industrial machine has multiple components (cf. FIG. 1, with xx and yy), and each component usually has more than one sensor. From a different point of view, groups 101 and 102 can stand for two industrial machines that have further components and sensors.

Component 110-xx provides source data from many parameter-specific sensors, and the simplification to a single digital sensor 120-xx stands pars pro toto for a sensor that can be a pressure sensor, a temperature sensor, a volume level sensor, a power sensor, a material color sensor and so on.

Components 110-xx have the common property with the common parameter. As the figure has its focus on data translation, it should be assumed that source data 221-xx and target data 222-xx should be related to the common parameter (common to all components 110-11 to 110-22). At any particular point in time (e.g., at tm, or during particular time interval, the sensor reading time that is associated with tm), parameter values can be provided for all components 110-11 to 110-22. The skilled person understands that digital sensors 120-xx may not provide source data 121-xx at exactly the same time-point, but for the purpose if this discussion it does not matter if for example, sensor 120-11 provides data a couple of seconds later than sensor 120-12.

For simplicity of explanation, the figure shows an easy-to-visualize example. The components should be the above-mentioned vessels (or tanks, or reactors etc.) that keep a particular volume of material. The common property should be the fact that the volume level parameter applies to all vessels, and that the volume level parameters is the common parameters that has to be processed by digital equivalents 210-xx. The figure symbolizes this parameter by bi-directional vertical arrows (inside the components).

Digital sensors 120-xx represent the parameter values (here the levels with volume values), and digital sensors 120-xx should provide source data 221-xx as a parameter identifier in combination with parameter values (more details also in FIGS. 7A, 7B). For example—in xx notation for (11, 12, 21, 22, 23)—the parameter identifiers are (In, In, Vol, Vol, Vol) to indicate that the volume of material inside the vessel has been measured (or identified otherwise, cf. FIG. 9). It is noted that having a common parameter does not mean to have common identifiers. The parameter values are for example (1.5, 3.0, 3.0, 1.0, 2.0). For simplicity, the values are given here without measurement units. It is further noted that to have a common parameter does not mean to use common values (in terms of data format, in terms of measurement unit etc.)

For simplicity of explanation, it can be assumed that operator 290 needs to have an overview to the relative material level at each of the components 110-xx. In the figure, the relative material levels correspond to the lengths of the vertical arrows. However, this does not necessarily correspond to the sensor readings.

Translations could be defined manually by investigating the identifiers. The identifier “In” could have been derived from “in-take” (or from “Inhalt” the German word for “content”), and “Vol” could have been derived from “volume”. As sensors 120-xx are level sensors (here in the example), a first translation rule could be defined for the syntax: translate “in” to “V” and translate “Vol” to “V.

For the parameter values, a second translation rule could be defined by taking the overall component capacities into account, the rule could be defined as
for component 120-11: divide the value by 2, and
for components 120-11,-21,-22,-23: divide the value by 4

Such rules would be considered to support semantic transformation: the absolute level values are transformed to relative level values.

In application of the rules, the data would be transformed to (V 0.75, V 0.75, V 0.75, V 0.25, V 0.5), i.e., to target data 222-xx. The figure illustrates that target data 222-xx symbolically in a user interface by black dots in relation to a center line (above, above, above, below, on the line). For operator 290 that might be indicative to derive a conclusion. For example, operator 290 might investigate why component 110-22 has some space unused.

However, manually defining the translations might not cover all possibilities. The following is just an overview to potential constraints:
Errors can be expected for human made definitions, and a confusion may be detected only when the digital equivalents start to return control signals. In the example, the control signal to stop pouring material may come too late (leading to spill-over).
The user interface symbols in equivalents 210-xx may have only 3 states (because only 3 symbols would be defined as “above the line”, “on the line”, and “below the line”, cf. the black dots in symbols 252-xx in FIG. 3). But a simple calculation by a division rule does not necessarily identify the position of the dot. For example, a measured value 1.2 divided by 2 leading to calculated 0.6 would not yet give the position of the dot.
Some elements of the translation calculations may change over time. For example, a repair may promote component 110-11 from a “small” vessel to a “large” vessel, and sensor 120-11 would still remain the same. But that simple change would influence the division rule (divide by 4, not by 2 any longer). There is no guarantee to update the rule as well.
The identification with “In” and “Vol” is given here just for explanations, but in real implementations, such short words would be sufficient to distinguish multiple sensors. Sensor data 221-xx is not necessarily coded in a human-understandable format. For example, “In” could be misunderstood as “input”.
When new components are added (or when older components are removed), the translations would have to be adapted. The same applies for replacing the sensors. (As a side-note, industrial systems can be simulated, with adding or removing components in virtual realities, such as in twin systems, but the translations would have to be adapted in any case.)
Translation rules must technically by implemented. In case the rules would be implemented on the sensor (i.e., with the electronics on the sensor device), appropriate software would have to be added to the sensor. But a particular sensor might be part of a control loop that must not be modified, otherwise the technical safety of the component would no longer be guaranteed. In other words, a control loop that uses the original data convention—i.e., source data—may have been tested to comply with technical standards, it must therefore use the original data convention, otherwise the compliance with the technical standard would not be guaranteed. In case that a rule would be implemented on the “right side” (i.e., by representations 210-xx), the updated rule may not be applicable for all components, and the updated rule could not interfere with the standard-compliant control loop.
Metadata may not identify a particular sensor correctly. Incorrectly assigning particular IDs to particular sensors may occur at various occasions, for example, when sensors are registers in databases for the first time, when sensors are being repaired or replaced, when the database is being modified, etc.

Having components physically located at different sites may make the constraint more severe.

The example with the vessel is simplified because each vessel will eventually show all possible parameter values (from zero to full). But in principle, some sensor readings may occur less frequently than others, and the source-to-target translation (or conversion) must be correct and must be independent from the frequency.

### Translation Function Implemented by a Neural Network

The constraints can be mitigated by using a machine-learning translation approach. Machine-learning relies on historical data, and optionally on considering contexts.

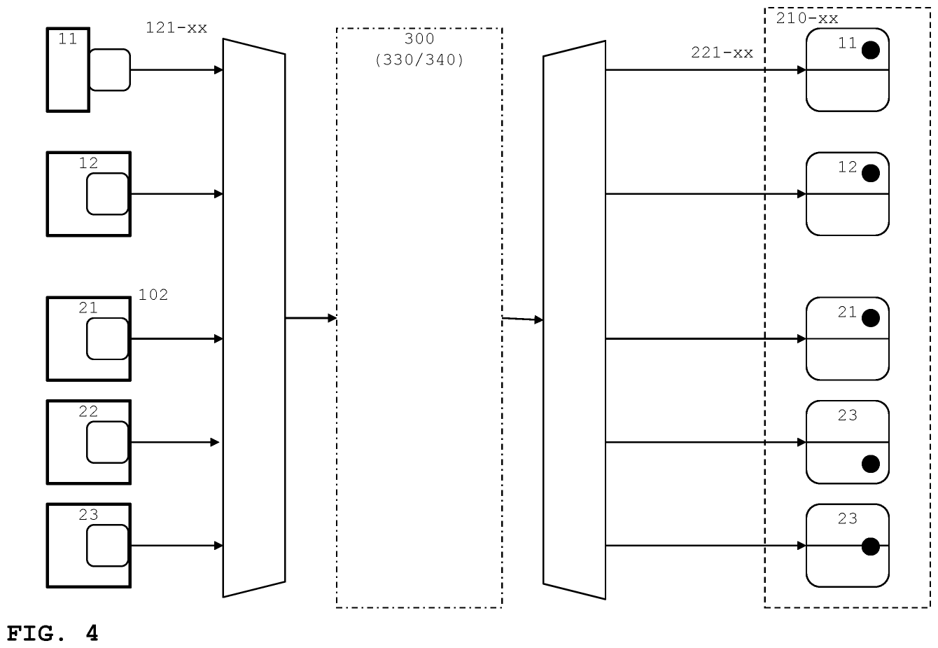

FIG. 4 again illustrates machine components 110-xx and digital equivalents 210-xx of FIG. 3 but illustrates translation function 300 in an implementation by a neural network 300 for harmonizing parameter data 221-xx from sensors 120-xx (source data) to translated data 221-xx (target data). (Reference 300 is used throughout the figures, for the function and for the structural implementation by the network).

As it will be explained in the following, translations 430-xx and 440-xx (of FIG. 3) can be implemented by one or more pre-trained networks (or sub-networks 330 and 340). Network 300 is the overall element that can implemented by one or more translation purpose specific networks. Network 300 is illustrated with multiplexers at the input (that receives source data) and at the output (that provides target data), multiplexing is just an example for a technique to symbolize that data belonging to different components needs to be separated.

This network approach changes, from manually defining the translation rules to defining the translation rules by machine learning. This may be advantageous, such as to mitigate the above constraints.

Although the examples for source and target data single data values that apply a particular point in time, the data could also be available in further dimensions (such as in space and time).

### Functions of the Network

FIGS. 5 and 6 illustrate two functions of network 300, for different translation purposes, cf. FIG. 3:
sub-network 330 provides syntax translations, and
sub-network 340 provides semantic translations.

The figures show network 300 during training (i.e., before it performs the method). In the figure, indices change from xx to hh, just to indicate that the training phase of FIGS. 5-6 is performed before the operation phase of FIGS. 3 and 4.

Although data from component 110-hh can provide data for the same component 110-xx (i.e., hh=xx), the components provide data for training and the trained network translates data from any component. A particular component (i.e., a component with a particular xx index is potentially not yet in operation), but the training comes from components that have been in operation in the past (i.e., to have historical data). It is convenient that the component 110-hh that has provided historical data is similar to the component 110-xx for that the translation should be applied (cf. FIG. 3, real-time). Using context (during training) may prevent the network being trained with data that would not fit (e.g., due to non-similarity).

The separation into groups is noted here. For example, the groups may cause different contexts so training within groups is preferred over training across groups.

The attributes “syntax” and “semantic” are given here for convenience of explanation only. The attribute gives an order: to identity a parameter first and to look at its value second.

The description will occasionally mention an “auxiliary network”. Such a network would operate in a known matter, different from the network in FIGS. 5 and 6.

In other words, historical source identifiers 231-hh, historical target parameter identifiers 232-hh, historical source values 241-hh, and historical target values 242-hh can be obtained from one or more further components 110-hh that are similar to component 110-xx of the industrial machine 100.

### Training (First Sub-Network)

FIG. 5 illustrates neural network 330 being trained with historical data. Neural network 330 (i.e., a sub-network to network 300) has the function to provide syntax translations (i.e., in the example to harmonized the parameter identifiers, not the parameter values).

In the example, historical data for training is a combination of parameter data (from the past) with human made annotations “V” (as ground truth).

The figure refers to the simplified example of FIG. 3. The network learns that “In” and “Vol” (at input 331) would have to be matched to “V” (at output 332 during training).

The figure also illustrates that occasional and incidental errors in the training data do not have an effect. The human-made annotations “P” to “In” does not lead to a rule, simply because the number of such annotations is relatively small. Or—to be more precise here—the annotation “P” would statistically not be representative, because of its nature to be an outlier, or an anomaly. Data processing techniques can be applied in advance, so that non-representative can be ignored for training. An example for such techniques is the application of an autoencoder, it would compress data (and thereby ignore P) and it would expand data (but data without P).

Similarly, there could be a data format “Inhalt” that does not have sufficient annotations. In other words, some sensors, especially if they are broken (or incorrectly calibrated) would provide data that is incomprehensible so that making annotations is not possible either. But such non-annotated data would no be used as training data.

When training is completed, network 330 receives meta-data (from various data sensors) of the same kind (e.g., all pressure sensors) and provides harmonized identifiers.

Optionally, historical context data 261-hh is provided to input 331 as well. Data 261-hh is provided to identifier pairs 231-hh, 232-hh simultaneously: data corresponds in time, for example, CONTEXT_A, state 0 is the context that applies to the four pairs on the left side of FIG. 5, and when the network under training processes these individual four pairs, it also processes the context. The network receives other context data (CONTEXT_B) when it processes the next pairs, and so on.

There are at least the following options:
In a first option, the computer processes multi-variate time-series {{X}} with (substantially all) variates n=1 to N, cf. FIG. 2. The figure illustrates context data synchronized with the annotations and with the parameter identifiers, as {X}1 standing for the variates at t=t1 and so on. The time with index m goes from left to right.
In a second option, the computer processes {{X}} but only as a sub-set of the data that qualifies as context (cf. FIG. 2 that shows contexts 501, 502 in dashed frames).
In a third option, the computer processes a descriptor of the context, such as “context 1” (from t1 to t4) and “context 2” (from t5 to t9), cf. FIG. 2 as well
In a fourth option, the computer processes a descriptor of a state, cf. FIG. 2 for the example with states S0 and S1.

Supplying context during training may be advantageous, because that also addresses the low-frequency-of-occurrence constraint. In a particular context, in that most of the “In” and “vol” are annotated with “V”, the human-made annotations “P” to “In” does not lead to a rule, as mentioned. But in a different context—and the network would learn this—such an annotation may point to an event that has a relatively low occurrence frequency. Such an event (e.g., spill-over) would have to be reported to digital equivalent 210-xx as well, and proper harmonization of parameter data is a condition for that.

### Training (Second Sub-Network)

FIG. 6 illustrate the neural network 340 being trained with historical data as well. Neural network 340 has the function to provide semantic translations. There are two inputs:
a sequence of measured values: 0.75, 0.75, 1.00, 0.00, 0.10, 0.50 (in the figure with reference 242-hh),
the corresponding sequence of components sizes: 2, 2, 2, 2, 2, 2 (the figure shows values for “small” components 110-11 of FIG. 3 only, reference 241-hh).

The ground truth (output to the network, during training) is a sequence of annotations: 0.75, 0.75, 1.00, 0.00, 0.10, 0.50. In the example the annotations have the meaning: “3 quarter”, “3 quarter”, “full”, “empty”, “almost empty”, “half full”.

The annotations could match, for example, to the dot symbols in equivalents 210-xx of FIG. 3. During training, the historic data will eventually comprise 1.2 in the first line, with annotations to “half full”.

Similar to the illustration in FIG. 5, network 340 (when being trained) can optionally be trained with historical context data 271-hh. In such cases, data 271-hh could be processed simultaneously with parameter value pairs 241-hh and 242-hh. The figure is simplified in writing CONTEXT, but context can change over time (cf. the discussion of context 501 and 502 in FIG. 2). Context 261-hh (in FIG. 5) and context 271-hh (in FIG. 6) can be the same data, but in most cases they would be different (because the historical data may come from different time points in the past).

The description has explained networks 330 and 340 separately, but both networks can be implemented to a single network (the sub-functions 330 and 340 would be network modules).

### Training Summary

In other words, training can be described as a computer-implemented method for training network 300 (having first sub-network 330 and having second sub-network 340). Network 300 is being trained for subsequent use in computer-implemented method 400 (cf. FIGS. 7A, 7B) for harmonizing parameter data from a plurality of source conventions to a single target convention. Data flows through the first and second sub-networks 330, 340 from inputs 331/341 to outputs 332/342 (cf. FIGS. 5-6).

As explained above, parameter data relate to components 110-xx of industrial machines 100. Parameter datasets 221-xx represent technical parameters that belong to components 110-xx, and parameter datasets 221-xx have parameter identifiers 231-xx and have parameter values 241-xx. In the source conventions, there are source parameter identifiers 231-xx and source parameter values 241-xx. In the single target convention, there are target parameter identifiers 232-xx and target parameter values 242-xx.

The method comprises training the first sub-network 330 with a plurality of historical parameter identifier pairs 231-hh, 232-hh, with historical source parameter identifiers 231-hh at input 331 of first sub-network 330 and historical target parameter identifiers 232-hh at output 332 of first sub-network 330.

The method further comprises training second sub-network 340 with a plurality of historical parameter value pairs 241-hh, 242-hh with historical source values 241-hh at input 341 of second sub-network 340 and historical target values 242-hh at output 342 of second sub-network 340.

An overall method can be defined by a computer-implemented method for training the network and a computer-implemented method for harmonizing parameter data (cf. method 400 and the details described herein).

### Training Accuracy

Source and target data are represented by data elements in a pre-defined order of identifier and value. The order could be changed.

But such ordered data has some remote similarity to code in a programming language (such as source code) and similarity to texts in human language.

In case of computer languages, compilers or interpreters are established.

In case of human languages, training could be compared to train a language translator. The source would be a sequence (time-series) of words such as “vol”, “In” etc. and the target would be sequence (also a time-series) of more standardized words (such as “V”). As human made text shows inevitable errors (cf. historical mismatches in FIG. 5), language translators would be robust to such errors.

Accuracy is related to the quality of the control data from equivalents 210-xx. To stay with the vessel example, the computer could be programmed to stop the material flow for a context (or a state) that would be “spill-over”. It does not matter if such a state would be aggregated individually by the components (from source data) or would be aggregated by the computer (from target data, e.g., if V reaches 1). But in the second case, the translation to target data must fit. Incorrect state data would result in missed stop signals.

Taking the context into account (already during training), and also at present (i.e., at time-point tm when the parameter may reach V=1), may reduce the risk of malfunction.

### IMPLEMENTATION DETAILS

Suitable networks (for 330/340 and for 300) are the following:
RNN (recurrent neural network)
LSTM (long short-term memory network)
CNN (convolutional neural network)
GRU (gated recurrent unit)
GPT

An overview to such networks is available in a paper by Huihui Zhang et al.: “A Novel Encoder-Decoder Model for Multivariate Time Series Forecasting”, Comput Intell Neurosci. 2022; 2022:5596676. published online 2022 Apr. 14. doi: 10.1155/2022/5596676.

Time-series forecasting with deep learning is explained in the following survey paper: Lim, B, Zohren S. 2021 Time-series forecasting with deep learning: asurvey. Phil. Trans.R. Soc. A 379: 20200209.https://doi.org/10.1098/rsta.2020.0209.

Regarding RNN, the following is useful as well: Kyunghyun Cho et al. “Learning Phrase Representations using RNN Encoder-Decoder for Statistical Machine Translation”. arXiv:1406.1078v3

Regarding the context, FIGS. 5-6 are simplified by showing single inputs 331, 332 for networks 330, 340 to receive context (during training asin FIGS. 5-6, as well as during operations, cf. FIG. 3).

2D contexts (such as context 501) can go into neural networks via separate network layers. Techniques for receiving data in 2D vector arrays are known in the art, for example in a paper by Yunhao Zhang and Junchi Yan: CROSSFORMER: TRANSFORMER UTILIZING CROSSDIMENSION DEPENDENCY FOR MULTIVARIATE TIME SERIES FORECASTING (MOE Key Lab of Artificial Intelligence, Shanghai Jiao Tong University and Shanghai Al Lab. Published as a conference paper at ICLR 2023)

### Transfer Learning

Shortly referring back to FIG. 3, different groups (components 110-11/110-12 and 110-21/110-22/110-23) may have different operation history. One group may be in operation for years, and the other group may belong to a new site. The same applies for single components. A new component may serve as the replacement for an old one, but there is potentially no time to manually replace all source-to-target relations.

Components without history (no matter if grouped or not) do not provide historical data, but in order to learn the translations, historical data from “long-history” components can step in.

Such transfer learning is further supported if descriptive data regarding “long-history” components is added to the training data. Training data (cf. FIGS. 5 and 6) is not limited to historical identifiers and values, but can comprise component type identification (e.g., large vessel, small vessel). For example, if a “small-size” component (such as component 110-11) would added, the networks would apply translations for such “small-size” components.

Such identification is an example for context (cf. FIGS. 5, 261-hh) that can support training optionally.

### Method Flow Chart

FIG. 7A illustrates a flow-chart of computer-implemented method 400 for harmonizing parameter data 221-xx from sensors 120-xx. The figure illustrates a classical flow-chart with method step 410, 420, 430 and 440 on the right side, but also illustrates first and second sub-networks 330, 340 with input and output.

Computer-implemented method 400 is a method for harmonizing parameter data.

In step receiving 410, the computer receives (from a component 110-xx of industrial machine 100, cf. FIG. 3), source parameter dataset 221-xx that represents a technical parameter. The technical parameter belongs to the component. Source parameter dataset 221-xx has source parameter identifier 231-xx and source parameter value 241-xx.

The computer uses first sub-network 330 of pre-trained network 300, and in step matching 420, the computer matches source parameter identifier 231-xx to target parameter identifier 232-xx. (As explained with FIG. 5, first pre-trained sub-network 330 has been trained with a plurality of historical parameter identifier pairs 231-hh, 232-hh with historical source parameter identifiers 231-hh at its input 331 and historical target parameter identifiers 232-hh at its output 332).

The computer uses second sub-network 340 of pre-trained network 300, and in step matching 430, the computer matches source parameter value 241-xx to target parameter value 242-xx. As described and illustrated by the arrow “select” in FIG. 7A, second sub-network 340 (of pre-trained network 300), is being selected according to the target parameter identifier 232-xx. (As explained with FIG. 6, it has been trained with a plurality of historical parameter value pairs 241-hh, 242-hh with historical source values 241-hh at its input 341 and historical target values 242-hh at its output 342).

In step forwarding 440, the computer forwards both target parameter identifier 232-xx and target parameter value 242-xx to user-interface 200 (cf. FIG. 3) that shows user-interface element 210-xx that corresponds to component 110-xx of industrial machine 100 and that visualizes target parameter value 242-xx.

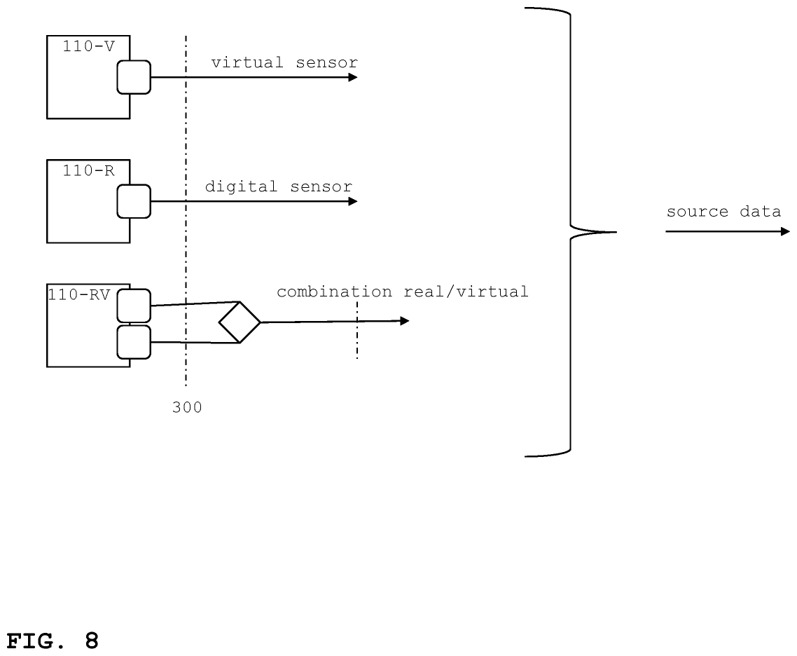

Optionally, source parameter dataset 221-xx represents a technical parameter that belongs to the component (110-xx) and that is a source parameter dataset from a digital sensor, or is a source parameter dataset from a virtual sensor (cf. FIG. 8-9).

Optionally, first sub-network 330, in addition to having been trained with a collection of parameter identifier pairs 231-h, 232-h, has simultaneously been trained with historical context data 261-hh at its input 331 (cf. FIG. 5). Optionally, following the same principle, second sub-network 340, in addition to having been trained with a collection of parameter value pairs 241-h, 241-h, has simultaneously been trained with historical context data 271-hh at its input 341 (cf. FIG. 6).

Optionally, step receiving 410 further comprises to identify real-time context 501, 502 (cf. FIG. 2) in that component 110-xx currently operates. The real-time context is a collection of data-points that are related to the data-point (Xmn) in the source parameter dataset 221-xx for the technical parameter. Identifying the real-time context can comprise to access state data (S0, S1), cf. FIG. 2.

Optionally, in step forwarding 440, the computer uses user-interface 200 to visualize target parameter value 242-xx by symbol 252-xx (cf. the example with a dot on a line, in FIGS. 2-3).

Optionally, after performing step receiving 410 (the source parameter dataset 221-xx), the computer uses first and second sub-networks 430, 440 to determine if source parameter dataset 221-xx fits a convention for target parameter dataset 222-xx. For a positive determination, method 400 continues with forwarding 450, thereby skipping the matching steps 430, 440. In other words, in case that a translation rule is available outside the networks, the rule is applied. Details will be explained in the following for missing identifiers and other circumstances.

Optionally, wherein forwarding 400 is followed by obtaining control signals to control the operation of the component 110-xx of the industrial machine 100. In other words, the computer becomes part of a control loop for the component and the data harmonization is one approach to obtain data to run that loop.

### Using Context Types in a Network Selection Cascade

FIG. 7B illustrates a flow-chart of computer-implemented method for harmonizing parameter data, as in FIG. 7A but also shows applying a network selection cascade that is context-sensitive.

As already mentioned above in the description of FIG. 7A, it is possible to identify real-time context (in that component 110-xx currently operates), and as explained with FIGS. 5-6, it is possible to feed context as data to the networks (e.g., historical context data 261-hh at its input 331, FIG. 5, during training). The networks (such as network 330 in FIG. 5 and network 340 in FIG. 6) would then process the context together with the parameter identifiers and the parameter values.

The arrow “select” in FIG. 7A already illustrates a selection: the output 232-xx (of first sub-network 330, output 232-xx being the target parameter identifier) serves as a selector for a particular second sub-network 340.

FIG. 7B illustrates method 400 as in FIG. 7A with an additional option: the context (that is a context type, cf. context_A, context_B, state 0, state 1 in FIG. 5) can be used to select a particular first sub-network 330 as well.

In that sense there is a context network 315 that identifies the context (that conceptionally comprises to identify a context type that is context at a coarser granularity, here given as the result of additional step 415). The identified context type is the selector of first sub-network 330. The number of trained sub-networks 330 corresponds to the number of context types. FIG. 7B symbolizes this number of dashed rectangles behind network 340. The number is not limited to 3 (as in the figure).

In that sense, FIG. 7B illustrates a selection sequence, with
determining the context type to select a particular first sub-network 340 from a plurality of pre-trained networks, with step 420 to follow as explained with FIG. 7A; and
determining second sub-network 340 according to the target parameter identifier 232-xx, as described with FIG. 7A.

Such a selection sequence can also be called as cascade, with a first determining step and a second determining step.

Context network 315 that identifies the context type can be implemented by a neural network as well. It can be trained with context (context 501, 502 is just an example) and annotations for context types. In relation to sub-networks 330 and 340, context network 315 would be an auxiliary network.

To summarize this section, method 400 is shown in an embodiment in that the method-executing computer (after receiving 410 the source parameter dataset: uses context network 315 to perform identifying 415 a context type, and selects a particular first sub-network 330 according to the context type, to perform the step matching 420 the source parameter identifier to the target parameter identifier.

### Sensor Implementations

FIG. 8 illustrates components 110-V, 110-R, 110-RV having different sensor implementations. As mentioned above, a digital sensor is a computing device that senses the physical phenomenon (that is a parameter), and that provides the parameter value (if available the identifier as well) in the form of digital data.

According to the implementation of the sensing, digital sensors can be differentiated into hardware sensors and software sensors. With the same meaning, this difference can also be expressed by differentiating real sensors 120-R and virtual sensors 120-V. Other synonyms would be “physical sensor” and “non-physical sensor”.

Component 110-R is a component having one or more sensors implemented as real sensor 120-R, and component 110-V is a component having one or more sensors implemented as virtual sensor 120-V.

Real sensors have physical elements that-in the broadest sense-are in contact with that part of the machine component for that the parameter applies. The following examples are useful for understanding.
A pressure sensor may have a membrane in contact with a gas or liquid and the bending of that membrane can be electronically sampled to obtain the pressure value.
A temperature sensor may have a temperature-sensitive element (e.g., resistor, transistor, thermistor etc.), and the element is surrounded with a material for that the temperature has to be known. Measuring the electrical current through the element leads to the temperature value.
A temperature sensor can be implemented as infrared thermometer (or even as infrared camera to measure temperature across a surface). The sensor would be “in contact” trough thermal radiation.

In contrast, virtual sensors do not have physical elements that can have such contact (with that part of the machine component to which the parameters apply). In other words, a virtual sensor is by definition providing a signal not measured by a physical instrument, so it can be the output of a simulation model or machine learning model, or a rule. An approach to implement such virtual sensors is described in the publication WO 2022/194871

The skilled person may select an appropriate sensor according to the construction of the component and according to the parameter. Installing a real sensor may not be possible, because the construction the component may simply not allow this. However, deriving parameter values with a virtual sensor might provide an alternative. For example, measuring the temperature of molten material within a furnace can be challenging because it would be difficult to place the temperature-responsive elements (together with cables and the like) inside the furnace. But using a virtual temperature sensor can provide temperature values (that have an accuracy that would fit most applications).

In both cases, the parameter data would be available, by direct measurement (real sensors) and indirect measurement (virtual sensors).

Consequently, a virtual sensor can obtain a parameters values for situations when using real sensors (i.e., hardware sensors) is not possible.

Component 110-RV is a component having one or more sensors implemented as a combination of virtual sensors and real sensors. The figures show a selection logic that outputs the sensor signal. The logic may—in real-time—select data according to the probability that the data corresponds to the parameter in reality: data with higher probability prevails. The skilled person can implement such selection, for example, by using auxiliary neural network (that are trained to determine the probability), by applying the Viterbi algorithm, or otherwise.

In all cases, components 110-R, 110-V or 110-RV would have their digital sensors to provide actual data (i.e., data that describes the parameter).

The design choice to use 110-R, 110-V or 110-RV depends on technical constraints of the component and on the availability of data. The following two examples are noted:
Contact or access to parameters favors real sensors,
Knowledge of relations between parameters (even if acquired through machine learning in auxiliary networks) may allow using virtual sensors.

For example, temperature and pressure inside a furnace (i.e., parameters in a system) may be difficult to measure by real sensors, but a relation from temperature and pressure to the wall temperature can be established (either by applying formulas, or by using a trained network). As the wall temperature can be measured (by a real sensor), the relation allows estimating temperature and pressure (i.e., virtual sensors).

### From Parameter Values to System States

As already mentioned with FIG. 2, the skilled person can abstract parameter data (as source data, or as target data) to system state data. For example, data “V 0.5”, “V 0.75” could be summarized to “normal” operation”, and data “V 1.0” could be summarized to “abnormal” operation. Other data could be considered as well. For example, data that indicates the flow of liquid into the tank in combination with “V 0.75” could lead to the state “overflow expected”.

Harmonizing can be applied to states as well: “overflow expected”, “spill-over approaching”, “more than full”, and other states can be harmonized (by network 300 if trained accordingly).

### From Components to Systems

FIG. 9 illustrates first, second, and third industrial machines 100, 100′ and 100′ each having a plurality of components 110. The components can be implemented as R, V or RV (cf. FIG. 8). As the components provide source data, translating by network 300 leads to target data. The same network can be used for all translating task, provided that data remains separated. Techniques for separating are known, among them multiplexing (cf. FIG. 4). Translating might not be required in all cases: source data can already be in the target format (identifier, values etc.). Optionally, network 300 determines if source data is in target format already or not.

The right-going arrows therefore symbolize harmonized data (in terms of identifiers/syntax, and values/semantic), going to twin components 210, 210′ and 210″ in twins 200, 200′ and 200″. Digital equivalents 210/210′/210″ can provide control signals. The figure is simplified in showing one control line only.

As parameter data (from the components) and control data (generally to the components, in particular to their actuators) are of the same structure (i.e., by harmonizing with the translation functions 300, as described; by de-harmonizing or adapting), parameter and control data can go into a pool of historical data. The pool can differentiate the origin (data associated with the first, second or third system).

The skilled person can provide historical data by applying calculations. For example, if the machine is a first blast furnace having a first volume, the activity to charge this first furnace by a first amount of material has its cross-multiplied equivalent to charge a second furnace having a second volume by a second amount.

If a new component (or even a new system) would be commissioned, the historical data can be used for a variety of purposes, among them
to use in prediction models to predict the operation of the new components (or system) even of the new component or system is not yet operative)

FIG. 9 therefore illustrates system 100″ by dashed lines. Its twin system 200″ could be installed before system 100″.

### Relations Between Parameters

The description now discusses relations between parameters, and hence between parameter data. Harmonizing is available likewise.

Two components with substantially the same construction may have a different number of sensors. It does not matter if the sensors are implemented as R or V sensors.

To stay with the above vessel or tank example, the components should not only have liquid stored at certain volumes, but they should store liquids at particular temperatures. The kind of liquid should be the same for both.

A first component should have a level sensor and a temperature sensor, and the second component should have a level sensor only. Alternatively, both components should have two sensors each, but in component 110-B the temperature sensor may fail.

Data could be collected as {{X}} for the first component, and as {{Y}} for the second component, with level and sensor data being variates.

The level sensors could be implemented by digital meters to measure the distance from the top of the vessels to the surface of the liquid inside the vessels. if the volume of the liquid increases, the distance decreases.

As the volume of the liquid is a function of the temperature, a temperature increase would come along with a volume increase, and a temperature decrease would cause a volume decrease. The relation between volume and temperature could also be used in absolute terms: the liquid has a certain volume at certain temperature. (Temperature-related volume changes of the vessels are neglected here.)

A network is able to learn the relation between both phenomena (i.e., volume and temperature in the example) so that missing data from source data is “translated” to target data. Here the translation function responds to a particular situation in that source data would not be available (at least for a particular variate) so that the target data would be established from processing source data that is available.

Optionally, the network can use context, such as state data that indicate the vessels storing liquids. Considering context can increase the accuracy, for example, in establishing the target parameter to be the volume parameter.

### Identifying Missing Identifiers

It is also contemplated to have a situation in that multiple sensors for the same parameter (e.g., both for volume) provide source data with different source parameter identifier (cf. 231-xx in FIG. 3). But occasionally, the source parameter identifier may simply be missing (for one of the sensors), or data field for the identifier may not be completed.

It is possible for the network to nevertheless identify the syntax (i.e., the derive the parameter identifier). In that case a network, like an autoencoder, would learn from a first component having 3 time series (source data) the correlations between the data.

### For Example,

for data from a first component, parameter A is correlated to parameter B at a level of 0.7. Parameter B is correlated to parameter C but with a delay of 10 minutes at a level of 0.2;
for data from a second component, a parameter identified as “PP” (being an arbitrary name here) is correlated to a parameter identified as “GG” at a level of 0.6, and “GG” is correlated to a parameter identified as “WW” but with a delay of 12 minutes at a level of 0.3.

This leads to first correlation pattern for the first component with sensors for parameters A, B, C, and to a second correlation pattern for the second component with sensors for parameters as identified as “PP”, “GG”, “WW”.

By processing (pattern matching, optimization, trial and error or “brute force”, it is possible to determine that
parameter A is associated with “PP”, so that identifiers A and “PP” point to the same phenomenon,
parameter B is associated with “GG”, so that identifiers B and “GG” point to the same phenomenon,
parameter C is associated with “WW”, so that identifiers C and “WW” point to the same phenomenon.

The example can be modified, for example by ignoring the temporal dimension. If a correlation is not yet identifiably, the correction can be assumed to be a permutation (e.g., with two alternatives), and the computer can eventually identify which alternative applies.

Autoencoders are networks, they are known in the art, the following papers may be convenient to consult: (i) Dor Bank, Noam Koenigstein, Raja Giryes: “Autoencoders” arXiv:2003.05991, and (ii) Michael Tschannen, Olivier Bachem, Mario Lucic: “Recent Advances in Autoencoder-Based Representation Learning” arXiv:1812.05069.

### Other Aspect for Identifiers

As in the examples, there is one syntax element per parameter: “In” or “Vol” both stand for “vol”, and the translation function (by the network) has been trained accordingly.

However, the number of syntax elements may vary. The pressure parameter is a convenient example to explain this.

Pressure can be measured in absolute terms (by force over area) or in relative terms (also force over area, but in relation between two media).

Identifiers may indicate such terms, for example, by writing “P=1000 hPa” (e.g., to indicate the pressure of the surrounding air, atmospheric pressure), or by writing “P=1 . . . over” (e.g., a more fictitious example for a vessel pressure that is twice the pressure of the surrounding air.

A couple of decades ago, the unit “at” was sometimes written as “atü” (for Überdruck=Overpressure).

In other words, the trained network derives missing data from the context of the source data.

In a further example, the context should be “surrounding air”. The context does not have to be named by such a label, but could be derived from {{X}} or {{Y}} data. In such a context, a measurement with values between, for example, “730” and “790” from a pressure sensor, could be associated by learning with the measurement unit being “Torr” or “mm Hg”.

### Simulation

Harmonizing data may be advantageous when simulations are involved.
A virtual sensor (120-V in FIG. 5) may comprise an (auxiliary) network for that training data could be provided by using the harmonization approach of method 400.
Parameter values (and states) may be the result of simulation.
Simulation has an accuracy that is different from actually measuring by real digital sensors. The network (being trained, or being used, FIG. 2A) could differentiate data from real and from virtual sensors.
Differentiation can be related to error correction. For example, the virtual sensor could optionally provide a confidence index.
Auxiliary networks or rules can detect suspicious values, can the networks (or the rules) could different for real sensors and for virtual sensors.

### Other Networks

In the context of industrial machines, (auxiliary) networks can be used for a variety of applications, such as to forecast or predict machine behavior.

As such networks need to be trained, harmonization would provide a further way to obtain training data. Training data from two different machines (or component) with different source data conventions would be merged to a harmonized pool with training data.

### Controlling the Machine

The above-described method 400 for harmonizing parameter data can be used by a computer system that specifies control data (cf. computer 200 in FIG. 1, the left-going arrow to the machine(s)) and that sends the control signals to multiple components (110-xx) of one or more industrial machines (100). As described, method 400 uses neural networks 330, 340 (FIGS. 7A, 7B) to determine translation rules by processing source parameter datasets (221-xx). The resulting target parameter data sets (222-xx) can be used by the computer to obtain the control signals.

In other words, method 400 has a further step to obtain the control signals.

The background section of this application has already mentioned control loops that are extended to control rooms. Method 400 can have its use in such control loops. Different data conventions may still lead to inappropriate actions, but the risk that such differences cause inappropriate actions can be reduced.

### Reversing the Translation Direction

So far the description has differentiated data into source data and target data by viewing the component (or the system) as the source and by viewing the component twin (or the system twin) as the target.

However, a twin (at both granularities: component twin and system twin) that processes harmonized data would eventually not differentiate the control signals to the actuators.

A digital actuator can be seen as a complement to a digital sensor. It receives control data and acts to change the physical phenomenon. A pressure sensor opens or closes a valve, a temperature actor can be a heater (or even a cooling device).

The above-mentioned constraints apply similarly. Different actuators-even for a common parameter—may require different control signals.

Translation function 300 could be applied to the reverse direction, with control data (or control signals, from the twin, from the computer) at its input and control data (to the component) at its output. Training and using networks would be similar.

### Application Use-Cases

As this disclosure has a focus on data processing, description and drawings refer to industrial machines in simplified illustrations. Machines and components are shown as vessels or the like. The above-identified publication WO 2022/194871 also mentions use-cases with blast furnaces. Applying the disclosure to such furnaces is possible as well.

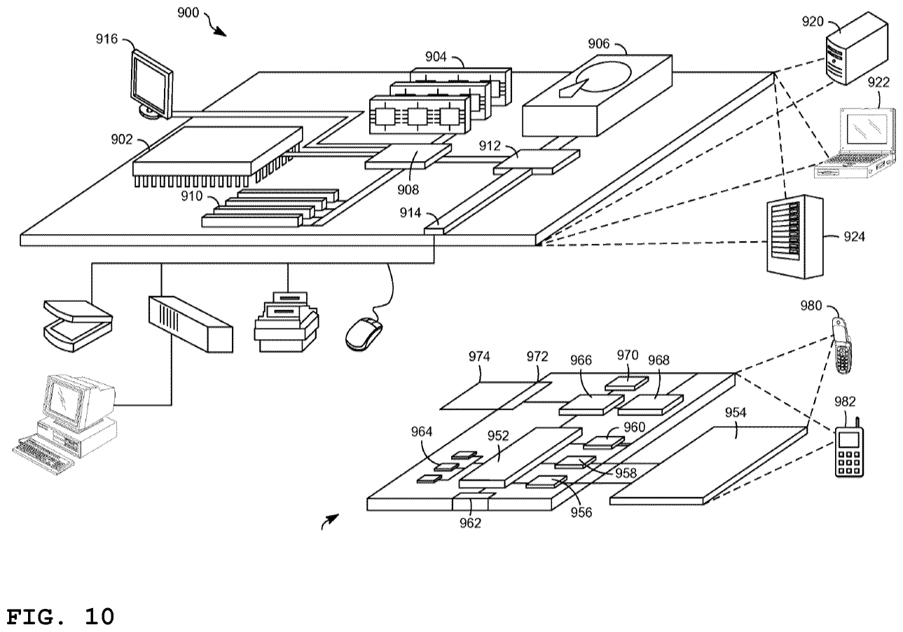

FIG. 10 illustrates an example of a generic computer device which may be used with the techniques described here. FIG. 10 is a diagram that shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smart phones, driving assistance systems or board computers of vehicles and other similar computing devices. For example, computing device 950 may be used as a frontend by a user (e.g., an operator of a blast furnace) to interact with the computing device 900. The components shown here, their connections and relationships, and their functions, are meant to be exemplary only, and are not meant to limit implementations of the disclosuredisclosures described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 904, the storage device 906, or memory on processor 902.

The high-speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 984 may also be provided and connected to device 950 through expansion interface 982, which may include, for example, a SIMM (Single In Line Memory Module) card interface. Such expansion memory 984 may provide extra storage space for device 950, or may also store applications or other information for device 950. Specifically, expansion memory 984 may include instructions to carry out or supplement the processes described above, and may include secure information also. Thus, for example, expansion memory 984 may act as a security module for device 950, and may be programmed with instructions that permit secure use of device 950. In addition, secure applications may be provided via the SIMM cards, along with additional information, such as placing the identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 984, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 980 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing device that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing device can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the disclosuredisclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A computer-implemented method for harmonizing parameter data, the method including the following steps:
receiving, from a component of an industrial machine a source parameter dataset that represents a technical parameter, wherein the technical parameter belongs to the component the source parameter dataset having a source parameter identifier and a source parameter value;
using a first sub-network of a pre-trained neural network, matching the source parameter identifier to a target parameter identifier wherein the first pre-trained sub-network has been trained with a plurality of historical parameter identifier pairs with historical source parameter identifiers at its input and historical target parameter identifiers at its output,
using a second sub-network of the pre-trained neural network matching the source parameter value to a target parameter value wherein the second sub-network of the pre-trained neural network
is being selected according to the target parameter identifier and
has been trained with a plurality of historical parameter value pairs with historical source values at its input and historical target values at its output; and
forwarding both the target parameter identifier and the target parameter value to a user-interface that shows a user-interface element that corresponds to the component of the industrial machine and that visualizes the target parameter value.

2. The method according to claim 1, wherein the first sub-network in addition to having been trained with a collection of parameter identifier pairs, has simultaneously been trained with historical context data at its input.

3. The method according to claim 1, wherein the second sub-network in addition to having been trained with a collection of parameter value pairs has simultaneously been trained with historical context data at its input.

4. The method according to claim 1, wherein step receiving further includes the step of identifying real-time context in which the component currently operates, wherein the real-time context is a collection of data-points that are related to a data-point in the source parameter dataset for the technical parameter.

5. The method according to claim 4, wherein in step receiving, identifying the real-time context comprises accessing state data

6. The method according to claim 1, wherein in step forwarding the user-interface visualizes the target parameter value by a symbol.

7. The method (400) according to claim 1, wherein after receiving the source parameter dataset the first and second sub-networks determine if the source parameter dataset fits a convention for the target parameter dataset, so that for a positive determination, the method continues with forwarding thereby skipping the matching steps.

8. The method according to claim 1, wherein after receiving the source parameter dataset the computer:
uses a context network to perform identifying a context type, and
selects a particular first sub-network according to the context type, to perform the step matching the source parameter identifier to the target parameter identifier.

9. The method according to claim 1, wherein forwarding is followed by obtaining control signals to control the operation of the component of the industrial machine.

10. A method for harmonizing parameter data according to claim 1, whereby a computer system specifies control data and that sends the control signals to one or more components of one or more industrial machines.

11. The computer system that is adapted to perform a method for harmonizing parameter data from a component of an industrial machine, with the method being a computer-implemented method according to claim 1.

12. A computer-implemented method for training a neural network having a first sub-network and having a second sub-network wherein the neural network is trained for subsequent use in a computer-implemented method for harmonizing parameter data from a plurality of source conventions to a single target convention, with a data flow through the first and second sub-networks from inputs to outputs;
wherein the parameter data relate to components of industrial machines, wherein parameter datasets represent technical parameters that belong to the components, wherein the parameter datasets have parameter identifiers and have parameter values;
wherein, in the source conventions, there are source parameter identifiers and source parameter values and wherein in the single target convention, there are target parameter identifiers and target parameter values; the method including the following steps:
training the first sub-network with a plurality of historical parameter identifier pairs, with historical source parameter identifiers at the input of the first sub-network and historical target parameter identifiers at the output of the first sub-network, and
training the second sub-network with a plurality of historical parameter value pairs with historical source values at the input of the second sub-network and historical target values at the output of the second sub-network.

13. The computer-implemented method according to claim 12, further comprising the steps of a computer-implemented method according to claim 1.

14. The computer program product that—when loaded into a memory of a computer and being executed by at least one processor of the computer causes the computer to perform the steps of the method according to claim 1.

15. The computer program product that when loaded into a memory of a computer and being executed by at least one processor of the computer causes the computer to perform the steps of the method according to claim 12.
